(19) United States
(12) Patent Application Publication
(10) Pub. No.: US 2004/0031348 A1
(43) Pub. Date: Feb. 19, 2004

(54) Adjustable handle for a cycle

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,739

(22) Filed: Aug. 13, 2002

(51) Int. Cl. B62K 21/16

(52) U.S. Cl. 74/551.3

(57) ABSTRACT

A cycle handle structure is composed of a base, a clamp and a handle. The clamp is welded on a post of the base. The clamp comprises a front piece and a rear piece, which enwraps the handle, whereas a knob protrudes outwardly from the handle to slide into a slot of the front piece of the clamp, that allows the knob to slide within the slot to adjust position of the handle for different users to the most appropriate position.

### FIELD OF THE INVENTION

This invention relates to a cycle handle structure, and more particularly to a handle that is able to adjust inclining position.

### BACKGROUND OF THE INVENTION

A tricycle, a stroller, a scooter or a child bicycle is convenient for a rider, however, all of these designs have the handle secured to the body in a fixed status. Therefore, when a child rides a cycle, his/her height does not fit the cycle, the riding causes an uncomfortable experience.

An improved cycle has been derived, which has a shaft B at the front end of a cycle body A. This shaft B is slidable up and down to adjust the height of the handle C for different riders. However, this design can adjust only the height of the handle not the inclination position, so this design is still not appropriate.

In view of this, the inventor has invented the present invention to improve the above-mentioned shortcomings.

### SUMMARY OF THE INVENTION

It is the primary object of the present invention to provide an adjustable handle for a cycle, which handle is able to adjust inclination position.

It is another object of the present invention to provide an adjustable handle for a cycle, which is easy to operate adjustment of the handle and safe to a user.

It is a further object of the present invention to provide an adjustable handle for a cycle, which is inexpensive in manufacture.

### BRIEF DESCRIPTION OF THE DRAWINGS

FIG. 1 is an exploded view of the present invention;

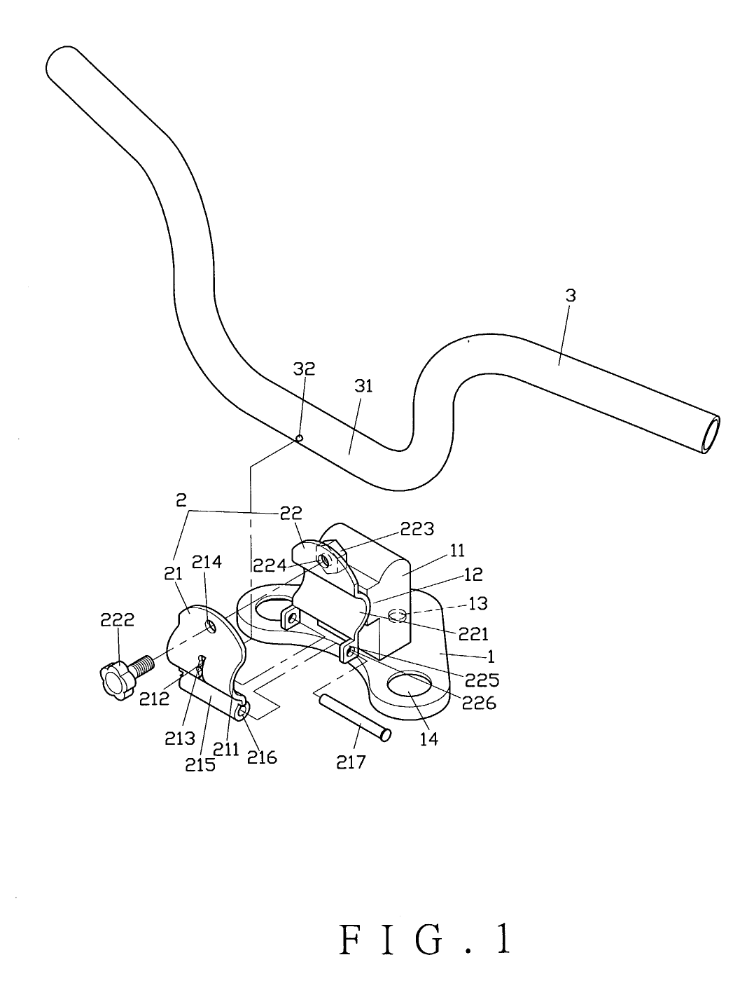

FIG. 2 is a perspective view of the present invention;

FIG. 3 is a side view of a bicycle incorporated with the present invention;

FIG. 4 is a cross-sectional view of the present invention;

FIG. 5 is a cross-sectional view of the present invention showing adjustment of the handle; and

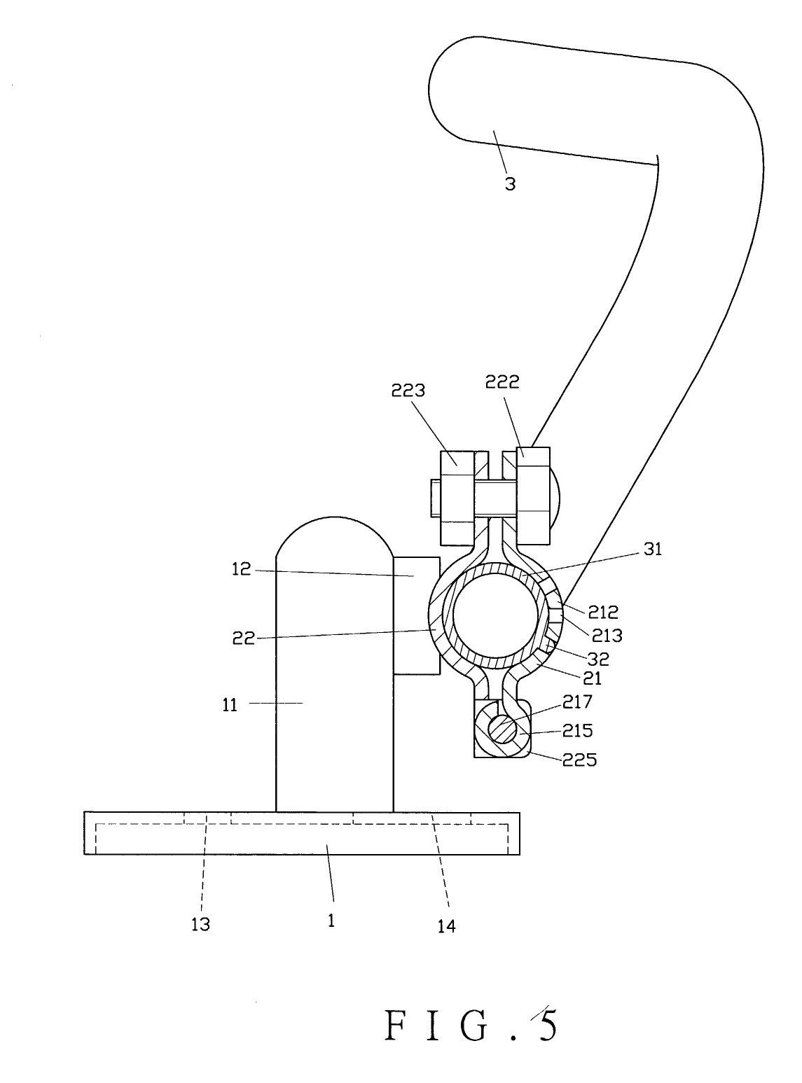

FIG. 6 is a side view of a prior art.

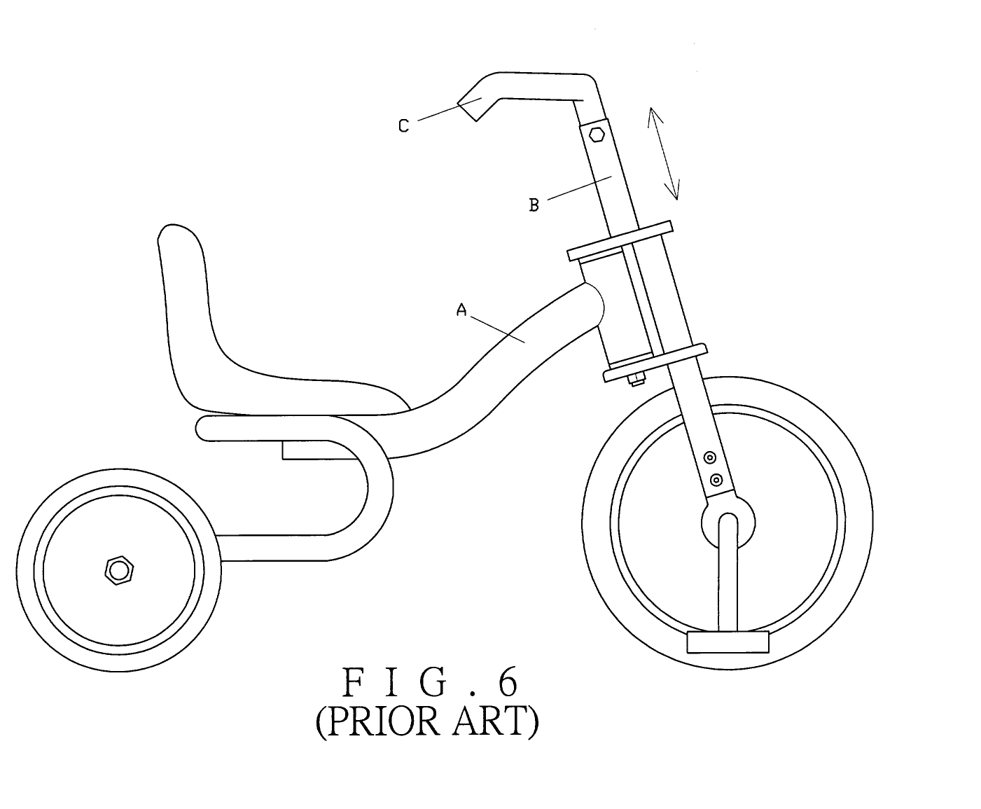

### DETAILED DESCRIPTION OF THE PREFERRED EMBODIMENT

The adjustable handle design of the present invention comprises a base 1, a clamp 2 and handle 3.

The base 1 has a triangle shape with a post 11 erected upwardly, the post 11 has a connecting area 12 at the front portion. The base 1 has a hole 13 behind the post 11 and a pair of locating holes 14 in front of the post 11.

The clamp 2 is securely fixed to the connecting area 12 of the post 11 of the base 1, so that it may not loose or disengage. The clamp 2 includes a front piece 21 and a rear piece 22. Both of the front piece 21 and the rear piece 22 have an arc recess 211 and 212, which are in corresponding position with each other. The front piece 21 has a slot 212 located at the recess 211, and a number of position holes 213 on the slot 212. Both of the front piece 21 and the rear piece 22 has a hole 214 and 224 above the recess 211 and 221. The rear piece 22 has a nut 223 secured to its rear end, which is adapted for a bolt 222 to secure therein. Both of the front piece 21 and the rear piece 22 comprise a pivoting area 215 and 225 below the recesses 211 and 221, and both of the pivoting area 215 and 225 comprise a pivoting hole 216 and 226 for insertion of a pin 217.

The handle 3 is to be secured in the recesses 211 and 221 of the front piece 21 and the rear piece 22, and has an arc supporting section 31. The supporting section 31 provides a knob 32 in relation to the position of the slot 212 of the front piece 21. The knob 32 is secured into the position hole 213 of the slot 212.

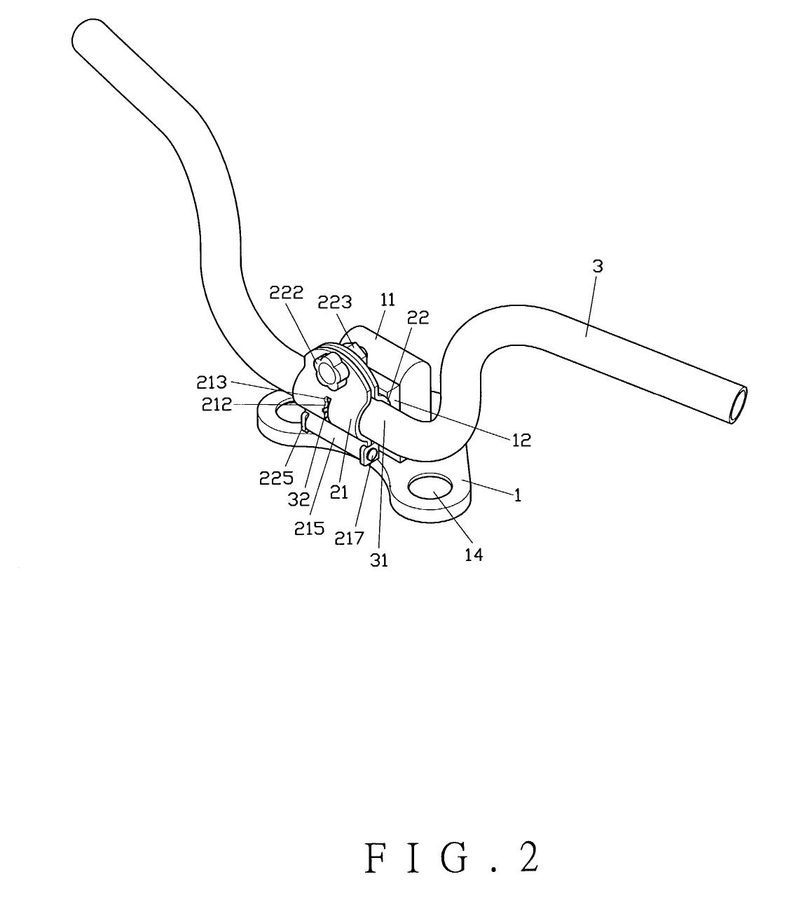

To assemble, as shown in FIG. 2, the connecting areas 215 and 225 are matched each other and the pivoting holes 216 and 226 are aligned, and then the pin 217 is inserted into the pivoting holes 216 and 226 of the connecting areas 215 and 225. This secures the front piece 21 and the rear piece 22 together, and is able to move freely with respect to each other. Then the supporting section 31 of the handle 3 is secured in the recesses 211 and 221 of the front piece 21 and the rear piece 22 with the knob 32 stayed in the slot 212 of the front piece 21. The knob 32 is able to slide up and down in the slot 212, and the knob 32 may be fixed in any of the position holes 213. Lastly, the bolt 222 is inserted into the holes 214 and 224 of the front piece 21 and rear piece 22 and tightened with the nut 223. The bolt 222 and the nut 223 may easily be turned to adjust the force of tightening the front piece 21 and the rear piece 22, therefore, the supporting section 31 of the handle 3 is secured thereat and may be adjusted easily.

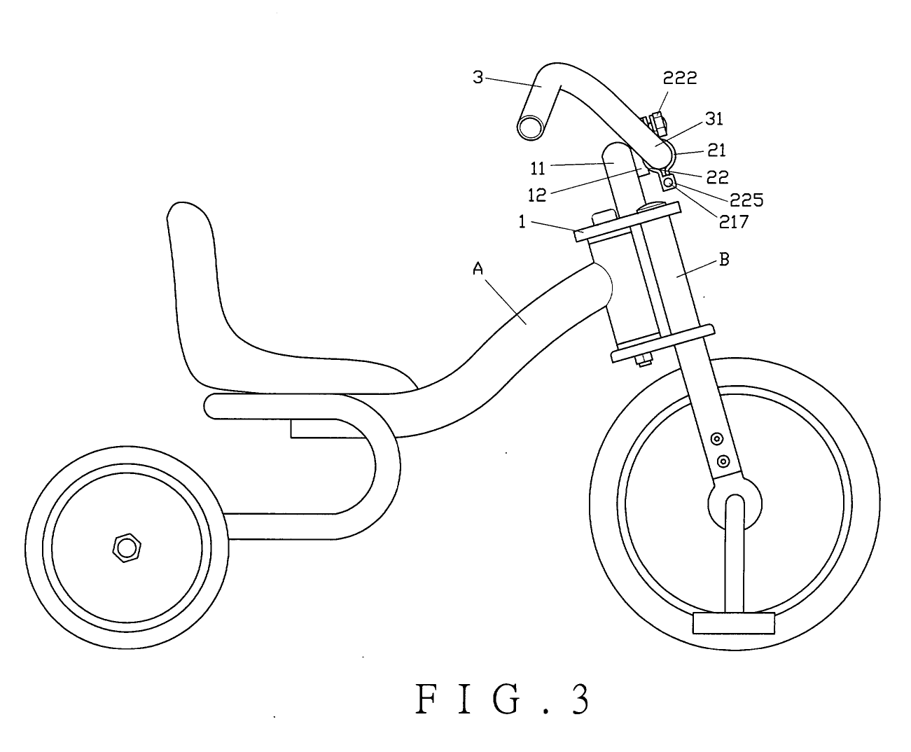

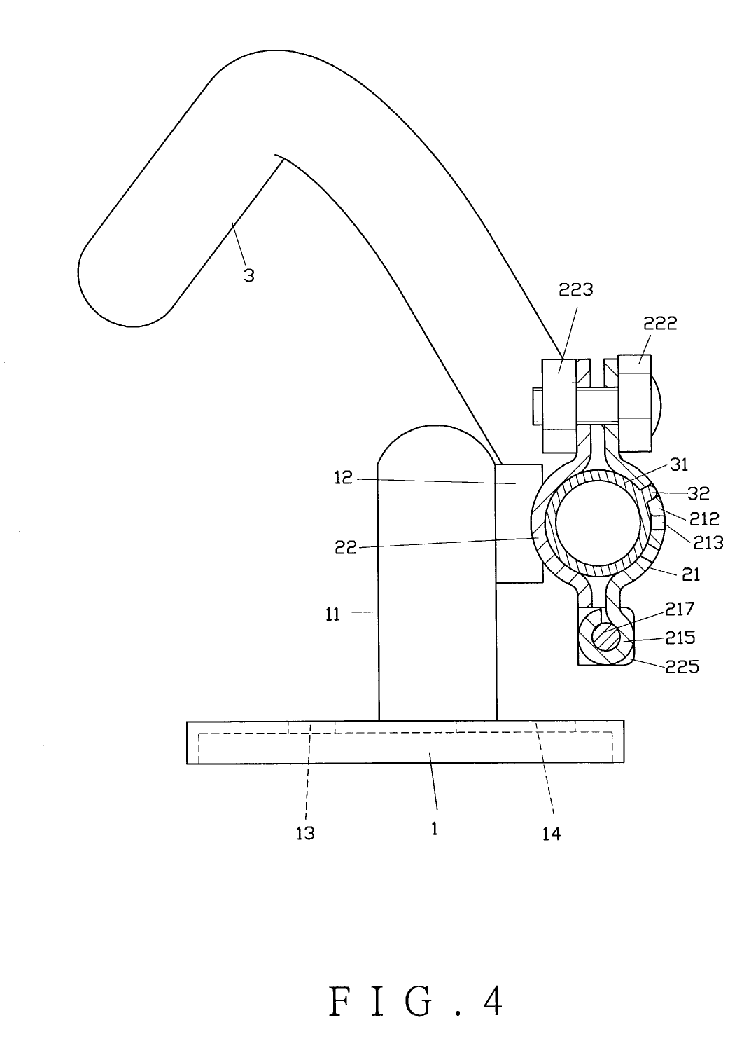

As shown in FIGS. 3 and 4, to operate the bicycle incorporated with the present invention, the base 1 is secured to a shaft B of a bicycle body A through the locating holes 14, and pivoted to the body A with the hole 13, whereas the base 1 is still free to move. When it is necessary to adjust the inclining position of the handle 3, it is simple to loosen the bolt 22, this loosens the front piece 21 and the rear piece 22, and the supporting section 31 of the handle 3 as well. This allows the supporting section 31 of the handle 3 to move back and forth in the recesses 211 and 221, this movement also makes the knob 32 detach from the position hole 213. When the handle 3 has reached to a position, the knob 32 will be located in another position hole 213. This secures the handle 3 at a fixed position. The adjustment of the handle 3 depends to a rider. When the adjustment has reached to an appropriate position, the bolt 222 is tightened and the front piece 21 and the rear piece 22 will be tightened together, therefore, the supporting section 31 of the handle 3 is tightened by the recesses 211 and 221 to provide a most comfortable and safe position for the rider.

The adjustable handle of the present invention can be applied to a tricycle, a scooter, or a child bike.

I claim:

1. An adjustable handle for a cycle comprising a base, a clamp, and a handle, wherein
said comprising a post erected upwardly therefrom,
said clamp being secured to said post of said base, and comprising a front piece and a rear piece being pivoted together, each of said front piece and said rear recess having a recess corresponding with each other, said front piece having a slot with a plurality of position holes thereon, both of said recesses of said front piece and said rear piece having a hole on the top position to receive a bolt inserting there through, and a nut fixed on the rear end of said rear piece to be threaded connection with said bolt.
said handle having a supporting section and being secured in said recesses of said front piece and said rear piece, said supporting section having a knob thereat to be engaged with one of said position holes of said slot of said front piece.

2. The adjustable handle for a cycle, as recited in claim 1, wherein said post protrudes a connecting area at the front for welding said clamp thereon.

3. The adjustable handle for a cycle, as recited in claim 1, wherein both of said front piece and said rear piece comprises a pivoting area to pivot each other by a pin to insert there through, which allows said front piece and said rear piece to open and close freely.
